(19) United States
(12) Patent Application Publication
(10) Pub. No.: US 2006/0117156 A1
(43) Pub. Date: Jun. 1, 2006

(54) Method and apparatus for dual protection of a protected memory block

(76) Inventors: Jesse C. Chai, Chandler, AZ (US); Matthew C. Meyer, Mesa, AZ (US)

Correspondence Address: MOTOROLA, INC., LAW DEPARTMENT, 1303 E. ALGONQUIN ROAD, SCHAUMBURG, IL, 60196, US

(21) Appl. No.: 11/001,481

(22) Filed: Dec. 1, 2004

(51) Int. Cl. G06F 12/14

(52) U.S. Cl. 711/163

(57) ABSTRACT

An apparatus and method for dual protection of a protected memory block (110) includes protected memory block (110) in a memory module (106), where the memory module is non-volatile and block-based. A memory controller (102) is coupled to access the protected memory block on the memory module, while a logic module (104) is coupled to and interposed between the memory controller and the memory module. The logic module is coupled to detect a hardware state (114) of a hardware source (108), and coupled to receive a write-protect signal (116) from the memory controller.

If the logic module detects the hardware state as a write permit state (118) and the logic module fails to receive the write-protect signal (116), the logic module permits the memory controller to modify the protected memory block. If the logic module either detects the hardware state is a write non-permit state (120) or receives the write-protect signal, the logic module prevents the memory controller from modifying the protected memory block. If the logic module detects the hardware state is a write non-permit state, the logic module prevents the memory controller from modifying the protected memory block.

### BACKGROUND OF THE INVENTION

Flash memory storage subsystems are being used more in digital system design. The flash memory storage can be used to. store BIOS/firmware code or debug code for the basic booting and post purposes. Preprogrammed firmware in the flash memory is often accidentally modified by simply removing the single available write protect mechanism, such as a hardware-only or software-only write-protect setting. This has the disadvantage of forcing a user to re-program the flash memory or send the digital device back to a supplier for reprogramming, thereby causing interruption.

Accordingly, there is a significant need for an apparatus and method that overcomes the deficiencies of the prior art outlined above.

### BRIEF DESCRIPTION OF THE DRAWINGS

Referring to the drawing:

FIG. 1 depicts a computer according to one embodiment of the invention; and

FIG. 2 illustrates a flow diagram of a method of the invention according to another embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

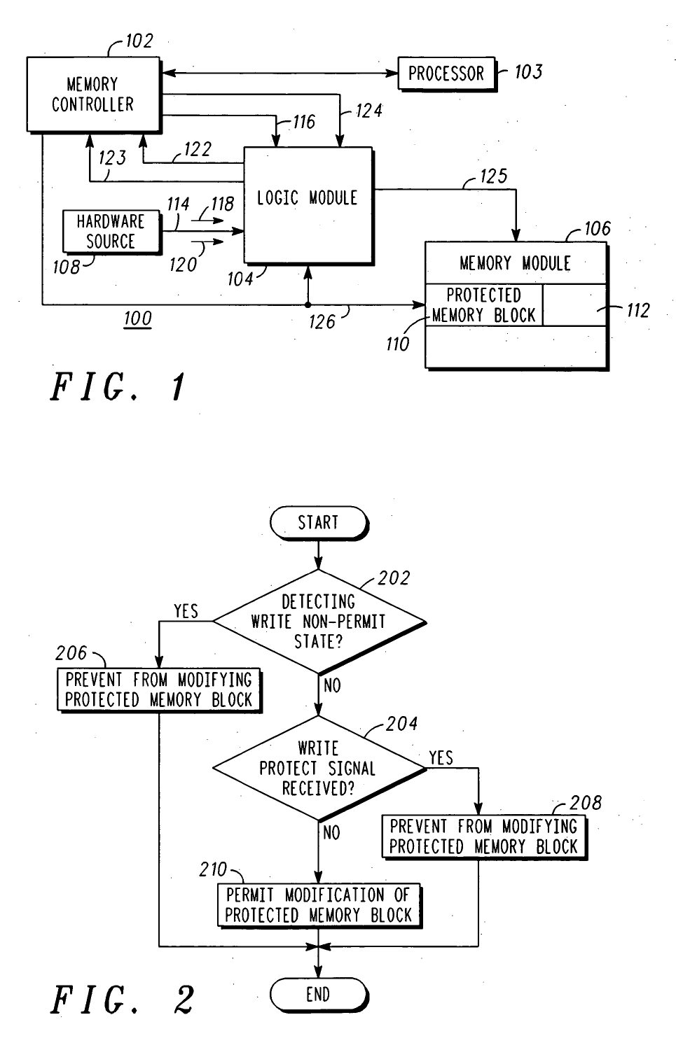

FIG. 1 depicts a computer 100 according to one embodiment of the invention. As shown in FIG. 1, computer 100 can include memory module 106 having any number of blocks of memory. Computer 100 can also include memory controller 102 and processor 103. Memory controller 106 can be used by processor 103 to access memory module 106 to perform read or write operations. In an embodiment, computer 100 can be an embedded computer module, for example a VMEbus computer module or a CompactPCI™ computer module. Embedded computer module can be, for example and without limitation, a card or blade coupled to a backplane in an embedded-type computer chassis. Embedded computing module can be a self-contained computer or part of a larger computer in an embedded computer chassis.

In an embodiment, computer 100 can include logic module 104 coupled to and interposed in between memory module 106 and memory controller 102. Logic module 104 can be, for example and without limitation, a programmable logic device such as a field programmable gate array (FPGA), and the like. In another embodiment, logic module 104 can be a set of discreet gates. In an embodiment, logic module 104 can include a set of registers having individual bits that can be set by receiving external signals or detecting the state of a device external to logic module 104. A logic module 104 that includes any means of outputting signals based on received signals or detected state of external devices is within the scope of the invention.

In an embodiment, memory module 106 can be non-volatile and block-based. Non-volatile memory is retained by a device when power is removed from that device. Block-based memory can include memory where a block of the memory must actually be addressed to be modified. For example, in non-block-based memory, a base block of memory can be addressed and subsequent blocks can be modified based on the base block of memory. In this instance, blocks of memory can be modified without being directly addressed. In non-block-based memory, a block of memory that is supposed to be write-protected can be modified by addressing and writing to a different, unprotected block of memory. In block-based memory, a particular block of memory must be directly addressed to be modified. For example, in block-based memory, a certain block of memory cannot be modified by addressing a different block of memory. In an embodiment, non-volatile, block-based memory can include, but is not limited to, flash memory, battery back-up SRAM, static RAM, EEPROM with a parallel interface, and the like. These examples are not limiting, and any memory having non-volatile and block-based characteristics is within the scope of the invention.

In an embodiment, memory module 106 can have any number of blocks of memory, where at least one block of memory is a protected memory block 110. In an embodiment, protected memory block 110 can include one or more blocks of memory of memory module 106. In another embodiment, all of the memory blocks in memory module 106 can be included in protected memory block 110.

In an embodiment, protected memory block 110 can include computer code, such as computer programs, data, and the like. In an embodiment, protected memory block 110 can include boot program 112. In an embodiment, boot program can include a Basic Input/Output System (BIOS), boot firmware, and the like. Boot program, 112 can be used to initialize computer 100. Protected memory block 110 can include one or more memory blocks that are protected from unintentional modification by the dual protection scheme described below.

In an embodiment, processor 103 can request access to memory on memory module 106 to either read data, write data or both. Memory controller 102 can implement requests of processor 103. In an embodiment, logic module 104 can determine if memory controller 102 has permission to modify protected memory block 110 based on inputs received by logic module 104.

In an embodiment, computer 100 can include hardware source 108 that is capable of setting a hardware state 114. Hardware source 108 can be any type of hardware that is manually or automatically operated by a user of computer. For example, and without limitation, hardware source 108 can be a switch, jumper, and the like. Hardware source 108 can generate a hardware state 114 that is capable of being detected by logic module 104. Hardware state 114 can be, for example, an electrical signal at any given voltage, a ground signal, and the like, that indicates the state of hardware source 108. For example, hardware source 108 can include a switch or a jumper, that when connected or engaged, couples logic module 104 to ground so that hardware state 114 can be a ground signal. In another embodiment, hardware source 108 can be connected or engaged to a voltage source such that logic module 104 is coupled to the voltage source to indicate hardware state 114. In an embodiment, hardware state 114 indicated by hardware source 108 can be binary. For example, if hardware source 108 is a jumper, the jumper is either in place or not in place. If the jumper couples logic module to ground, then logic module can detect hardware state 114 as either ground or not ground.

In an embodiment, hardware source 108 that is binary can indicate either of two states, for example a write permit state 118 or a write non-permit state 120. For example and without limitation, a hardware source 108 that has hardware state 114 that indicates a grounded condition can indicate a write non-permit state 120. The write non-permit state can occur, for example, when a jumper is installed at hardware source 108. When the jumper is not in place, hardware source 108 can indicate, for example, a write permit state. The invention is not limited by the above example. Hardware source indicate a voltage for either write permit state 118 or write non-permit state 120 and be within the scope of the invention. Any combination of hardware source 108 having a hardware state 114 that can indicate at least two states is within the scope of the invention.

Hardware state 114 of hardware source 108 can be detected by logic module 104. In an embodiment, if logic module 104 detects hardware state 114 of hardware source 108 to be write non-permit state 120, then logic module 104. prevents memory controller 102 from modifying protected memory block 110. Modifying protected memory block 110 can include writing additional data, erasing data, and the like, from protected memory block 110. If logic module 104 detects hardware state 114 of hardware source 108 to be write permit state 118, then logic module 104 permits memory controller 102 to modify protected memory block 110. However, in an embodiment, even if logic module 104 detects write permit state 118, memory controller 102 may still not be able to modify protected memory block 110 unless allowed by a software means as described below.

In an embodiment, logic module 104 can receive write-protect signal 116. If logic module 104 receives write-protect signal 116, then logic module 104 prevents memory controller 102 from modifying protected memory block 110. In an embodiment, in order for memory controller 102 to be able to modify protected memory block 110, logic module 104 must both detect write permit state 118 from hardware source 108 and fail to receive write-protect signal 116. If memory controller 102 is permitted to modify protected memory block 110, memory controller 102 can select memory module 106 using raw memor select signal 124 to instruct logic module 104 to select protected memory block 110 using controlled select signal 125. Memory controller 102 can address protected memory block 110 using addressing signal 126. Memory controller 102 can receive feedback on hardware state via hardware feedback signal 122. Memory controller 102 can receive feedback on status of write-protect signal 116 via software feedback signal 123.

If logic module 104 either detects write non-permit state 120 from hardware source 108 or receives write-protect signal 116, then logic module 104 prevents protected memory block 110 from being modified. For example, even if logic module 104 detects write permit state 118 from hardware source 108, receiving write-protect signal 116 prevents memory controller 102 from modifying protected memory block 110. Also, if hardware state 114 is write non-permit state 120 and write-protect signal 116 is not received, logic module 104 prevents memory controller 102 from modifying protected memory block 110.

In an embodiment, regardless of the condition of hardware state 114 or whether write-protect signal 116 is received, memory controller 102 is able to read from protected memory block 110. In another embodiment, protected memory block 110 comprises boot program 112, and the process for determining if memory controller 102 can modify protected memory block 110 can apply to modification of boot program 112.

FIG. 2 illustrates a flow diagram 200 of a method of the invention according to another embodiment of the invention. In step 202, logic module can detect whether hardware source is in write non-permit state. If so, in step 206, logic module prevents modification of protected memory block. If logic module does not detect write non-permit state in step 202, logic module queries whether write-protect signal is received in step 204. If write-protect signal is received, logic module prevents modification of protected memory block per step 208. If write-protect signal is not received, then logic module permits modification of protected memory block per step 210.

As illustrated above, protected memory block 110 is protected with a dual-protect scheme using a hardware state 114 of a hardware source 108 and a software source manifested in write-protect signal 116. In order to modify protected memory block 110, both hardware state 114 and software need to allow modification. If either the hardware source 108 or the software source indicates that protected memory block should be protected, logic module 104 prevents memory controller 102, or any other source, from modifying protected memory block 110.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. A computer, comprising:
a memory module, wherein the memory module is non-volatile and block-based;
a protected memory block in the memory module;
a memory controller coupled to access the protected memory block on the memory module; and
a logic module coupled to and interposed between the memory controller and the memory module, wherein the logic module is coupled to detect a hardware state of a hardware source, wherein the logic module is coupled to receive a write-protect signal from the memory controller, wherein if:
the hardware state is a write permit state and the write-protect signal is not received, the logic module permits the memory controller to modify the protected memory block;
wherein if:
one of the hardware state is a write non-permit state and the write-protect signal is received, the logic module prevents the memory controller from modifying the protected memory block;
and wherein if:
the hardware state is a write non-permit state, the logic module prevents the memory controller from modifying the protected memory block.

2. The computer of claim 1, wherein the logic module permitting the memory controller to modify comprises the logic module permitting the memory controller to write to the protected memory block.

3. The computer of claim 1, wherein the logic module preventing the memory controller from modifying comprises the logic module preventing the memory controller from writing to the protected memory block.

4. The computer of claim 1, wherein the logic module preventing the memory controller from modifying comprises the logic module preventing the memory controller from erasing from the protected memory block.

5. The computer of claim 1, wherein the protected memory block comprises a boot program.

6. The computer of claim 1, wherein if at least one of the hardware state is the write non-permit state and the write-protect signal is received, the memory controller can read from the protected memory block.

7. The computer of claim 1, wherein the hardware source is a switch.

8. The computer of claim 1, wherein the hardware source is a jumper.

9. A computer, comprising:
a memory module, wherein the memory module is non-volatile and block-based;
a boot program in the memory module;
a memory controller coupled to access the boot program on the memory module; and
a logic module coupled to and interposed between the memory controller and the memory module, wherein the logic module is coupled to detect a hardware state of a hardware source, wherein the logic module is coupled to receive a write-protect signal from the memory controller, wherein if:
the hardware state is a write permit state and the write-protect signal is not received, the logic module permits the memory controller to modify the boot program;
wherein if:
one of the hardware state is a write non-permit state and the write-protect signal is received, the logic module prevents the memory controller from modifying the boot program;
and wherein if:
the hardware state is a write non-permit state, the logic module prevents the memory controller from modifying the boot program.

10. The computer of claim 9, wherein the logic module permitting the memory controller to modify comprises the logic module permitting the memory controller to write to the boot program.

11. The computer of claim 9, wherein the logic module preventing the memory controller from modifying comprises the logic module preventing the memory controller from writing to the boot program.

12. The computer of claim 9, wherein the logic module preventing the memory controller from modifying comprises the logic module preventing the memory controller from erasing from the boot program.

13. The computer of claim 9, wherein if at least one of the hardware state is the write non-permit state and the write-protect signal is received, the memory controller can read from the boot program.

14. A VMEbus computing module, comprising:
a memory module, wherein the memory module is non-volatile and block-based;
a protected memory block in the memory module;
a memory controller coupled to access the protected memory block on the memory module; and
a logic module coupled to and interposed between the memory controller and the memory module, wherein the logic module is coupled to detect a hardware state of a hardware source, wherein the logic module is coupled to receive a write-protect signal from the memory controller, wherein if:
the hardware state is a write permit state and the write-protect signal is not received, the logic module permits the memory controller to modify the protected memory block;
wherein if:
one of the hardware state is a write non-permit state and the write-protect signal is received, the logic module prevents the memory controller from modifying the protected memory block;
and wherein if:
the hardware state is a write non-permit state, the logic module prevents the memory controller from modifying the protected memory block.

15. A CompactPCI computing module, comprising:
a memory module, wherein the memory module is non-volatile and block-based;
a protected memory block in the memory module;
a memory controller coupled to access the protected memory block on the memory module; and
a logic module coupled to and interposed between the memory controller and the memory module, wherein the logic module is coupled to detect a hardware state of a hardware source, wherein the logic module is coupled to receive a write-protect signal from the memory controller, wherein if:
the hardware state is a write permit state and the write-protect signal is not received, the logic module permits the memory controller to modify the protected memory block;
wherein if:
one of the hardware state is a write non-permit state and the write-protect signal is received, the logic module prevents the memory controller from modifying the protected memory block;
and wherein if:
the hardware state is a write non-permit state, the logic module prevents the memory controller from modifying the protected memory block.

16. An embedded computing module, comprising:
a memory module, wherein the memory module is non-volatile and block-based;
a protected memory block in the memory module;
a memory controller coupled to access the protected memory block on the memory module; and
a logic module coupled to and interposed between the memory controller and the memory module, wherein the logic module is coupled to detect a hardware state of a hardware source, wherein the logic module is coupled to receive a write-protect signal from the memory controller, wherein if:
the hardware state is a write permit state and the write-protect signal is not received, the logic module permits the memory controller to modify the protected memory block;
wherein if:
one of the hardware state is a write non-permit state and the write-protect signal is received, the logic module prevents the memory controller from modifying the protected memory block;
and wherein if:
the hardware state is a write non-permit state, the logic module prevents the memory controller from modifying the protected memory block.

17. A method, comprising:
providing a memory module, wherein the memory module is non-volatile and block-based;
providing a protected memory block in the memory module;
providing a memory controller coupled to access the protected memory block on the memory module;
providing a logic module coupled to and interposed between the memory controller and the memory module, wherein the logic module is coupled to detect a hardware state of a hardware source, wherein the logic module is coupled to receive a write-protect signal from the memory controller;
if the logic module detecting the hardware state is a write permit state and the logic module fails to receive the write-protect signal, the logic module permitting the memory controller to modify the protected memory block;
if one of detecting the hardware state is a write non-permit state and receiving the write-protect signal, the logic module preventing the memory controller from modifying the protected memory block; and
if detecting the hardware state is a write non-permit state, the logic module preventing the memory controller from modifying the protected memory block.

18. The method of claim 17, wherein the logic module permitting the memory controller to modify comprises the logic module permitting the memory controller to write to the protected memory block.

19. The method of claim 17, wherein the logic module preventing the memory controller from modifying comprises the logic module preventing the memory controller from writing to the, protected memory block.

20. The method of claim 17, wherein the logic module preventing the memory controller from modifying comprises the logic module preventing the memory controller from erasing from the protected memory block.

21. The method of claim 17, wherein if at least one of detecting the hardware state is the write non-permit state and receiving the write-protect signal, the memory controller reading from the protected memory block.

22. A method of dual protecting a boot program, comprising:
providing a memory module, wherein the memory module is non-volatile and block-based, and wherein the memory module comprises the boot program;
providing a memory controller coupled to access the boot program on the memory module;
providing a logic module coupled to and interposed between the memory controller and the memory module, wherein the logic module is coupled to detect a hardware state of a hardware source, wherein the logic module is coupled to receive a write-protect signal from the memory controller;
if the logic module detecting the hardware state is a write permit state and the logic module fails to receive the write-protect signal, the logic module permitting the memory controller to modify the boot program;
if one of detecting the hardware state is a write non-permit state and receiving the write-protect signal, the logic module preventing the memory controller from modifying the boot program; and
if detecting the hardware state is a write non-permit state, the logic module preventing the memory controller from modifying the boot program.

23. In an embedded computing module, a method of dual protection for a protected memory block, comprising:
providing a memory module, wherein the memory module is non-volatile and block-based, and wherein the memory module comprises the protected memory block;
providing a memory controller coupled to access the protected memory block on the memory module;
providing a logic module coupled to and interposed between the memory controller and the memory module, wherein the logic module is coupled to detect a hardware state of a hardware source, wherein the logic module is coupled to receive a write-protect signal from the memory controller;
if the logic module detecting the hardware state is a write permit state and the logic module fails to receive the write-protect signal, the logic module permitting the memory controller to modify the protected memory block;
if one of detecting the hardware state is a write non-permit state and receiving the write-protect signal, the logic module preventing the memory controller from modifying the protected memory block; and
if detecting the hardware state is a write non-permit state, the logic module preventing the memory controller from modifying the protected memory block.
